(19) United States
(12) Patent Application Publication
(10) Pub. No.: US 2002/0109584 A1
(43) Pub. Date: Aug. 15, 2002

(54) Data arrival informing system and method

(76) Inventor: Makoto Sakaki, Tokyo (JP)

Correspondence Address: Steven Weisburd, DICKSTEIN SHAPIRO MORIN & OSHINSKY LLP, 41st Floor, 1177 Avenue of the Americas, New York, NY, 10036-2714, US

(21) Appl. No.: 10/073,100

(22) Filed: Feb. 12, 2002

(30) Foreign Application Priority Data
Feb. 14, 2001 (JP) 036251/2001

(51) Int. Cl. H04Q 7/00

(52) U.S. Cl. 340/7.29; 455/412

(57) ABSTRACT

Data transmitted from a data transmission server 1 to a certain user arrives at a network gateway 2 via an internet 100, and is received in an arrived data receiving means 31 of an arrived data dealing function part 3 provided in the inside. Then, a data arrival information determining means 32 determines the data arrival information type on the basis of the type of terminal of the pertinent user as stored in an individual user terminal type memory 33, a data arrival information editing means 34 edits data arrival information on the basis of the data received by the received data and data arrival information type, and a data arrival information transmitting means 35 transmits data arrival information to the terminal used by the user. The transmitted data arrival information arrives at a user terminal 4 via a radio network 200.

### BACKGROUND OF THE INVENTION

This application claims benefit of Japanese Patent Application No. 2001-036251 filed on Feb. 14, 2001, the contents of which are incorporated by the reference.

The present invention relates to data arrival informing systems and, more particularly, to data arrival informing methods of informing the arrival of new data from the network side to the user.

Heretofore, this type of data arrival informing method have been calling for increased demand for system, which permit a user to be instantly informed of the arrival of an electronic mail or like data addressed to the user. To meet this demand, a system is necessary, which can inform the arrival of new data from the network side to the user without periodic confirmation by the user of the arrival or non-arrival of new data from the network. In an exemplified such system, data arrival information is transmitted from a network gateway to the user.

In the above prior art data arrival informing method, it is not necessary as a system for informing data arrival to the user terminal to take the presence of a plurality of different terminal types and also a plurality of different radio networks into considerations. However, with the advance of network accessing systems utilizing radio networks, it has become necessary to take the plurality of different terminal types and the plurality of different radio networks into considerations.

### SUMMARY OF THE INVENTION

An object of the present invention, accordingly, is to provide data arrival informing system and method capable of transmitting data arrival information to the user by taking the difference of the terminal used by each user to each user.

According to an aspect of the present invention, there is provided a data arrival informing system for informing data arrival to a user terminal in a network accessing environment based on a radio network, comprising a data arrival information dealing means for transmitting data arrival information by taking the difference of the type of each user terminal into considerations.

According to another aspect of the present invention, there is provided a data arrival informing method for informing data arrival to a user terminal in a network accessing environment based on a radio network, comprising a data arrival information dealing step for transmitting data arrival information by taking the difference of the type of each user terminal into considerations.

In the data arrival informing system according to the present invention, the data transmitted from a data transmission server to a user arrives at a network gateway via an internet, and is received in an arrived data receiving means of an arrived data dealing function part provided in the inside. Then, a data arrival information type determining means determines the data arrival information type on the basis of the type of terminal used by the pertinent user as stored in an individual user terminal type memory, a data arrival information editing means edits data arrival information on the basis of the received data and data arrival information type, and a data arrival information transmitting means transmits data arrival information to the terminal used by the user. Thus, it is possible to transmit data arrival information suited for the type of terminal used by the user.

While individual user terminal types are assumed to be stored in the individual user terminal memory, it is also possible to permit, for the data arrival information type determination, the reading of a dynamically stored user terminal type from the individual user terminal type memory.

Other objects and features will be clarified from the following description with reference to attached drawings.

### BRIEF DESCRIPTION OF THE DRAWINGS

FIG. 1 is a block diagram showing the construction of an embodiment of the data arrival informing system according to the present invention;

FIG. 2 is a flow chart illustrating the operation of the embodiment of the data arrival informing system according to the present invention;

FIG. 3 is a view showing data transmitted from the data transmission server 1;

FIGS. 4(a) and 4(b) are views showing data preserved in the individual user terminal type memory 33 shown in FIG. 1;

FIG. 5 is a view showing the result of editing in the data arrival information editing means 34 shown in FIG. 1;

FIG. 6 is a block diagram showing the construction of a different embodiment of the data arrival information informing system according to the present invention;

FIG. 7 is a flow chart illustrating the operation of the access gateway function group part 5 shown in FIG. 1;

FIG. 8 is a flow chart illustrating the operation of the whole data arrival informing system as the other embodiment of the present invention; and

FIG. 9 is a view showing a data-obtaining request transmitted from the user terminal 4.

### PREFERRED EMBODIMENTS OF THE INVENTION

Preferred embodiments of the present invention will now be described with reference to the drawings.

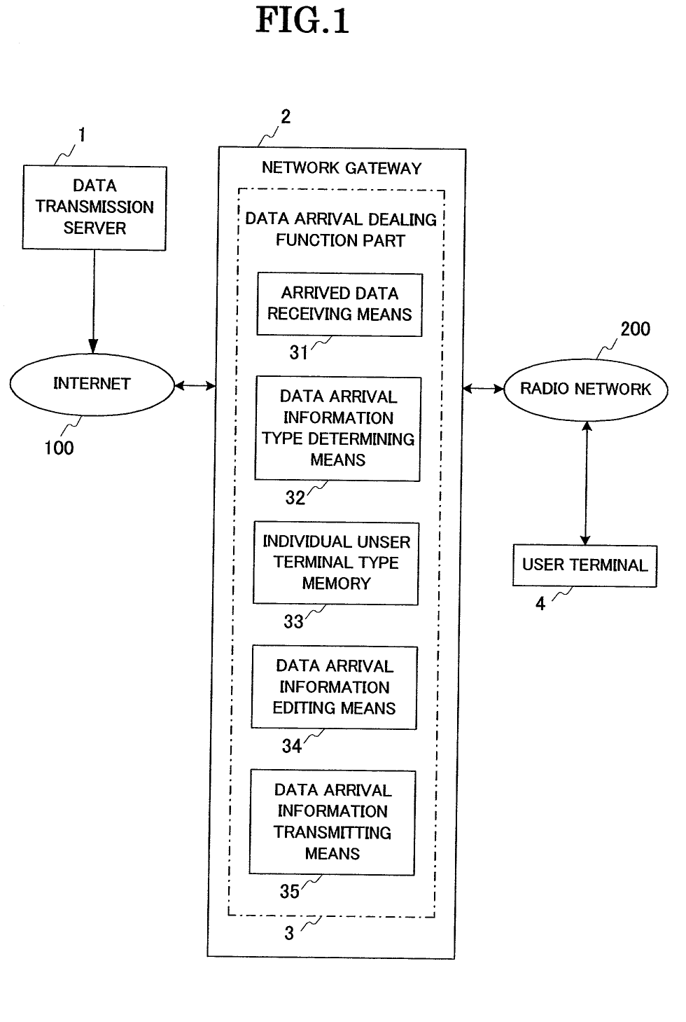

FIG. 1 is a block diagram showing the construction of an embodiment of the data arrival informing system according to the present invention. Referring to FIG. 1, the illustrated embodiment of the data arrival informing system according to the present invention comprises a data transmission server 1, an internet 100, a network gateway 2, a radio network 200 and a user terminal 4.

The data transmission server 1 transmits data, which is deemed to finally arrive at a particular user, to the Internet 100. The Internet 100 is a general Internet for relaying data transmitted from the data transmission server 1. The network gateway 2 includes a data arrival information dealing function part 3. The data arrival dealing function part 3 has an arrived data receiving means 31, a data arrival information type determining means 32, an individual user terminal type memory 33, a data arrival information editing means 34, and a data arrival information transmitting means 35.

The arrived data receiving means 31 receives the data, which has been transmitted from the data transmission server 1 and arrived at the network gateway 2 via the Internet 100. The data arrival information type determining means 32 reads out the type of terminal used by the data arrival destination user from the individual user terminal type memory 33, and determines the type of data arrival information to be transmitted to the destination user. In the individual user terminal type memory 33, the type of terminal used by each user is stored. The data arrival information editing means 34 executes the data arrival information editing on the basis of the data received by the arrived data receiving means 31 and the determined data arrival information type. The data arrival information transmitting means 35 transmits data arrival information, which is worked out by taking adequate radio network, data transfer protocol, connection system, maximum received data quantity, data description language, etc. into considerations, to the destination user on the basis of the type of data arrival information determined in the data arrival information type determining means 32.

The radio network 200 may be world-wide known GSM (Global System for Mobile communication), GPRS (General Packet Radio Service), CDMA (Code Division Multiple Access), PDC (Personal Digital Cellular), etc., and the data transfer protocol may be IP (Internet Protocol), SMS (Short Message Service), etc. The connection system may be circuit switching system, packet switching system, etc.

The user terminal 4 has a radio network accessing function, and interprets data arrival information. Among what are estimated as user terminal 4, the supporting radio network, data transfer protocol, connection system, maximum received data quantity, data description language, etc., may not be the same, and they can be distinguished on the basis of the terminal type.

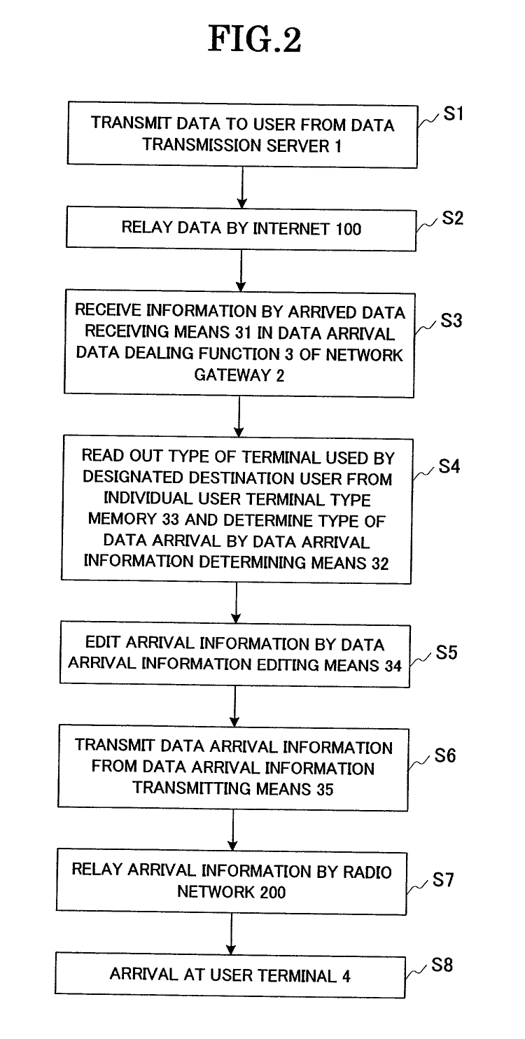

FIG. 2 is a flow chart illustrating the operation of the embodiment of the data arrival informing system according to the present invention. The operation of the embodiment of the data arrival informing system according to the present invention will now be described.

First, the data transmission server 1 transmits data to the user (step S1 in FIG. 2). The transmitted data is relayed by the Internet 100 (step S2 in FIG. 2), and received in the arrived data receiving means 31 in the data arrival data dealing function part 3 in the network gateway 2 (step S3 in FIG. 2). In the information received in the arrived data receiving means 31, the destination user of the information is designated. The data arrival information determining means 32 reads out the type of the terminal used by the designated destination user, and determines the type of the data arrival information transmitted to the destination user (step S4 FIG. 2). It is assumed that the type of the terminal, used by each user has been registered beforehand by a network operator or the like in the individual user terminal type memory 33.

The data arrival information editing means 34 edits the data arrival information by selecting the adequate maximum received data quantity, data description language, etc. toward the destination user on the basis of the data arrival information type determined in the data arrival information type determining means 32 (step S5 in FIG. 2). The data arrival information transmitting means 35 selects adequate radio network, data transfer protocol, connection system, etc. for the destination user on the basis of the data arrival information type determined in the data arrival information determining means 32, and transmits the data arrival information edited in the data arrival information editing means 34 (step S6 in FIG. 2). The arrival information transmitted from the data arrival transmitting means 35 is relayed by the radio network 200 (step S7 in FIG. 2), and arrives at the user terminal 4 (step S8 in FIG. 2).

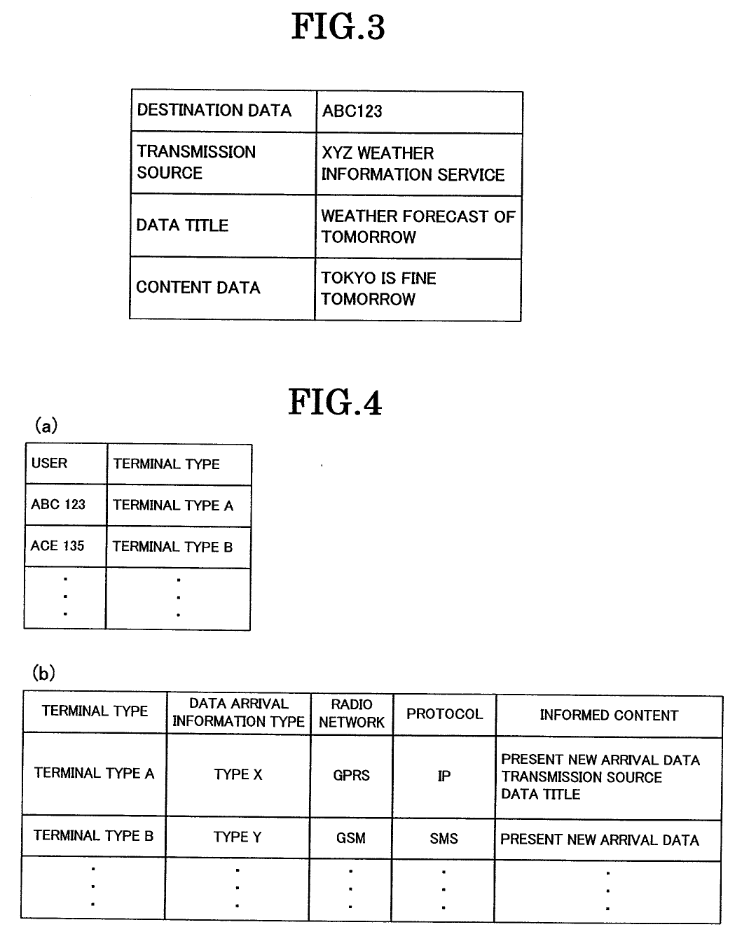

FIG. 3 is a view showing data transmitted from the data transmission server 1. Referring to the Figure, the data transmitted from the data transmission server 1 includes those of destination user “ABC123”, data transmission source “XYZ weather information service”, information title “Weather Forecast of Tomorrow” and contents “Tokyo is fine tomorrow.”

FIGS. 4(a) and 4(b) are views showing data preserved in the individual user terminal type memory 33 shown in FIG. 1. Referring to FIG. 4(a), terminal type data “Terminal Type A”, “Terminal Type B”, . . . , of the individual users “ABC123”, “ACE135”, . . . are preserved in the individual user terminal type memory 33. Referring to FIG. 4(b), data arrival information type data “type X”, “type Y”, . . . , radio network data “GPRS”, “GSM”, . . . , protocol data “IP”, “SMS”, . . . and information content data “new data arrival information”, “data transmission source”, “data title”, . . . are stored for the individual terminal types, i.e., “terminal type A”, “terminal type B”, . . . in the individual user terminal type memory 33.

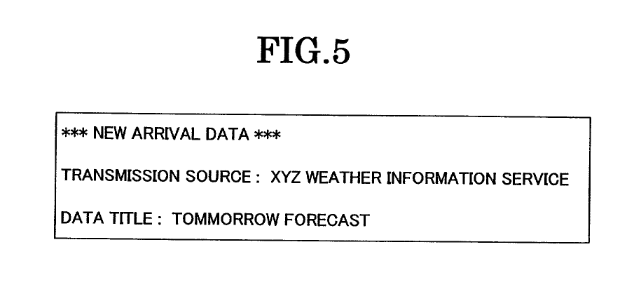

FIG. 5 is a view showing the result of editing in the data arrival information editing means 34 shown in FIG. 1. The data arrival information editing means 34 edits “new data arrival information” as comprising “data transmission source”, “XYZ weather information service”, “information title” and “weather forecast for tomorrow”.

The operation of the whole data arrival informing system as one embodiment of the present invention will now be described in detail with reference to FIGS. 1 to 5.

It is now assumed that the data as shown in FIG. 3 is transmitted from the data transmission server 1 and received in the arrived data receiving means (steps S1 to S3 in FIG. 2). If the data as shown in FIG. 4 is stored in the individual user terminal type memory 33 at this time, the data arrival information type determining means 32 reads out the type of terminal used by the destination user “ABC123” from the individual user terminal type memory 43. The data arrival information type determining means 32 thus determines that the type of terminal used by the destination user “ABC123” is “terminal type A” and that the type of data arrival information to be transmitted to the “terminal type A” user is “type X” (step S4 in FIG. 2).

The data arrival information editing means 34 edits the data arrival information on the basis of the data shown in FIG. 3 and “type X” as the data arrival information type. In this case, the contents of the data arrival information to be transmitted are new data arrival, the data transmission source and the data title, and the editing means 34 thus edits the new data arrival information as shown in FIG. 5.

The data arrival information transmitting means 35 transmits the data arrival information to the destination user on the basis of “type X” as the data arrival information type and by using “GPRS” as adequate radio network and “IP” as data transfer protocol (step S6 in FIG. 2). The transmitted data arrival information arrives at the user terminal 4 via the radio network 200 (steps S7 and S8 in FIG. 2).

As shown above, in the network gateway 2, the individual user terminal types are stored, the optimum data arrival information type is determined from among the stored terminal types, data arrival information is edited in conformity to the determined data arrival information type, and the edited data arrival information is transmitted by selecting the adequate radio network system, the data transfer protocol, etc. Thus, it is possible to transmit data arrival information to each user by taking the difference of the terminal used by each user into considerations.

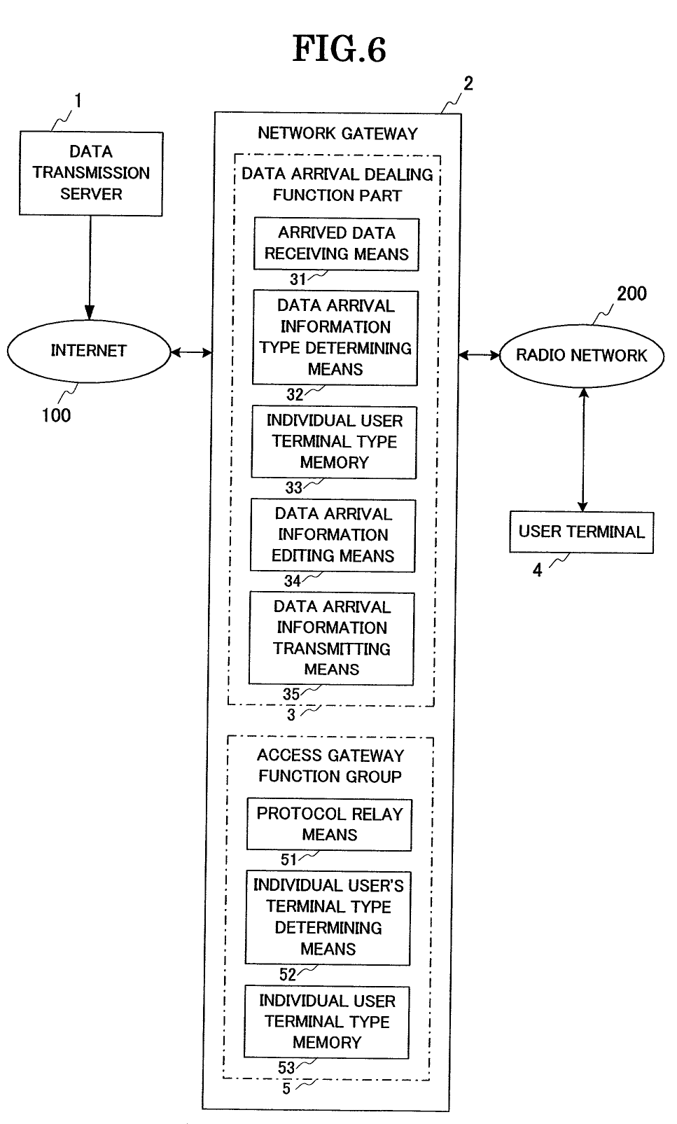

FIG. 6 is a block diagram showing the construction of a different embodiment of the data arrival information informing system according to the present invention. Referring to the Figure, this embodiment of the data arrival informing system according to the present invention is substantially the same in construction as the embodiment of the data arrival informing system shown in FIG. 1 except for the provision of an access gateway function group part 5 as a function group in the network gateway 2, and like parts or elements are designated by like reference numerals. The operations of the like parts or elements are like those in the first, i.e., FIG. 1, embodiment of the present invention.

The access gateway function group part 5 includes a protocol relaying means 51, an individual user terminal type determining means 52, and an individual user terminal type memory 53. The protocol relaying means 51 relays any request for obtaining data transmitted from the user terminal 4 and present in the internet 100 or the like.

The individual terminal type determining means 52 reads out the terminal type contained in the request for obtaining data transmitted from the user terminal 4 and present in the internet 100 or like, and causes the read-out data to be stored in the individual user terminal type memory 53. The individual terminal type memory 53 stores terminal type as determined in the individual terminal determining means 52.

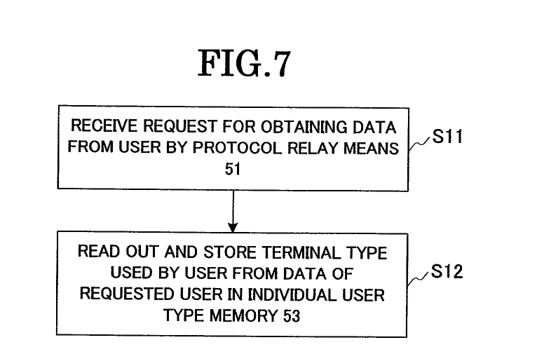

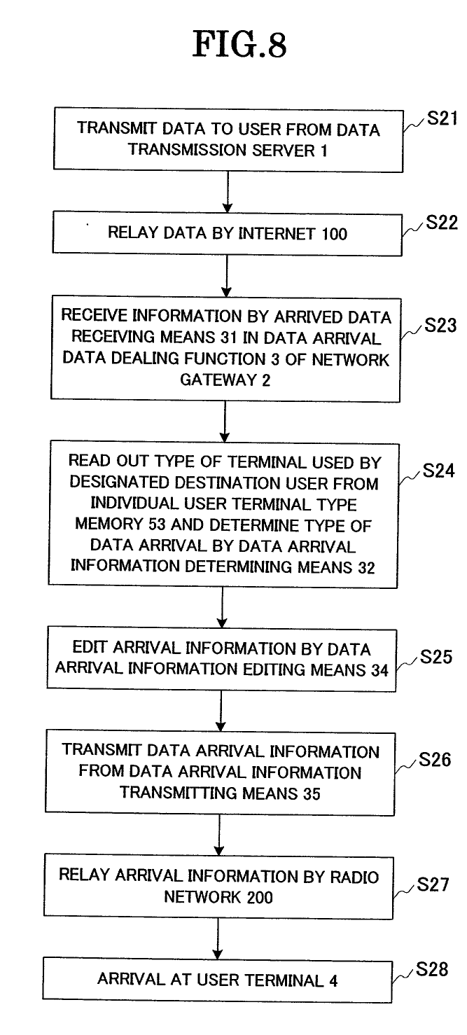

FIG. 7 is a flow chart illustrating the operation of the access gateway function group part 5 shown in FIG. 1. FIG. 8 is a flow chart illustrating the operation of the whole data arrival informing system as the other embodiment of the present invention. The operation of the data arrival informing system as the other embodiment of the present invention will now be described with reference to FIGS. 6 to 8.

The operations of the data transmission server 1, the internet 100, the arrived data receiving means 31, the data arrival information editing means 34, the data arrival information transmitting means 35, the radio network 200 and the user terminal 4 in this embodiment, as shown as the steps S21 to S23 and S25 to S28 shown in FIG. 8, are the same as the operations of the steps S1 to S3 and S5 to S8 in the data arrival informing system as the embodiment of the present invention shown in FIG. 2.

First, the user terminal 4 executes a request for obtaining data present in the Internet 100 or the like. The protocol relaying means 51 receives the request (step S11 in FIG. 7). The individual user terminal type determining means 52 reads out the type of terminal used by the user from data of the requested user and the terminal type contained in the request, and causes the read-out data to be stored in the individual user terminal type memory 53 (step S12 in FIG. 7). In this way, the type of the pertinent user terminal is stored in the individual user type memory 53.

In the embodiment of the present invention shown in FIG. 1, when data is transmitted from the data transmission server 1 to the user, the data arrival information type determining means 32 reads out the type of terminal used by the user from the individual user terminal type memory 33, in which the type of terminal used by the destination user has been preliminarily stored.

In this embodiment, on the other hand, at the time of reception of the request from the user for obtaining data, the data arrival information type is determined by reading out dynamically stored user terminal type for each user from the individual user terminal type memory 53 (step S24 in FIG. 8).

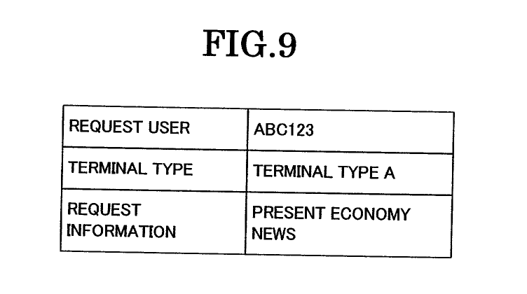

FIG. 9 is a view showing a data-obtaining request transmitted from the user terminal 4. In the Figure, the data-obtaining request includes destination user “ABC123”, terminal type “terminal type A” and request data “newest economical news”.

The operation of the whole data arrival informing system as the other embodiment of the present invention will now be described in detail with reference to FIGS. 6 to 9. As in the above case, it is assumed that the data transmitted from the data transmission server 1 and the result of editing in the data arrival information editing means 34 are as shown in FIGS. 3 and 5, respectively.

It is assumed that the data-obtaining request as shown in FIG. 9 is transmitted from the user terminal and received in the protocol relaying means (step S11 in FIG. 7). The individual terminal type determining means 52 reads out “terminal type A” as the type of terminal used by the user “ABC123”, and causes the read-out terminal type stored in the individual user terminal type memory 53 (step S12 in FIG. 7).

It is now assumed that data as shown in FIG. 3 is transmitted from the data transmission server 1 and received in the data arrival information receiving means 31 (steps S21 to S23 in FIG. 8). In the individual user terminal type memory 53 as shown in FIG. 4, data as shown in FIG. 4 is held, which has been stored in the above step S12.

The data arrival information type determining means 32 reads out the type of terminal used by the destination user “ABC123” from the individual user terminal type memory 53. It is determined that the type of terminal used by the user “ABC123” is “terminal type A” and that the type of data arrival information transmitted to the user of “terminal type A” is “type X” (step S24 in FIG. 8).

The data arrival information editing means 34 edits data arrival information on the basis of the data shown in FIG. 3 and “type X” as data arrival information type. At this time, the data arrival information to be transmitted is edited as shown in FIG. 5 because its contents are the new arrival of data, the data transmission source and the title of the data (step S25 in FIG. 8).

The data arrival information transmitting means 35 transmits the data arrival information on the basis of the “type X” as the data arrival information type and by using “GPRS” system as the adequate radio network and “IP” as the data transfer protocol. The data arrival information thus arrives at the user terminal 4 via the radio network 200 (steps S26 to S28 in FIG. 8).

This embodiment provides an advantage that when the user as the subscriber of a plurality of terminals selectively uses these terminals with an SIM (Subscriber Identity Module) card or the like by determining the type of terminal used by the user on the basis of a data-obtaining request therefrom, the user can effect proper data arrival information transmission by determining not the type of a terminal preliminarily registered by any network operator but the type of terminal used at the time of obtaining recent data.

The above embodiments have been described in connection with the case, in which the data-obtaining request from the user contains the terminal type and also the memory stores the data arrival information type corresponding to the terminal type with the data thereof containing the radio network type, the protocol type and the information contents, it is also possible that the data-obtaining request from the user contains data arrival information type, radio network type, protocol type, information contents and so forth.

The protocol used by the user at the time of data-obtaining request, may be HTTP (Hypertext Transfer Protocol) or the like as well. When using the HTTP, the user-agent header may contain the terminal type.

The above embodiments have concerned the case, in which the data arrival information type data contains the radio network type, the protocol type and the information contents. However, it is also possible that the data arrival information type data contains maximum data quantity capable of being dealt with in the terminal, information as to whether the terminal is a color terminal, language supported by the terminal, terminal display screen size, image format supported by the terminal and so forth. The above embodiments have also concerned the case, in which the timing of storing the terminal type in the individual user terminal type memory 53 is the timing of provision of a request for obtaining data present in the internet 100 or the like from the user terminal 4. However, it is also possible to prepare a server for definitely reporting the terminal type and let the terminal type be stored in the individual user terminal memory 53 at the timing when the user terminal 4 accesses the definite terminal type reporting server.

As has been described in the foregoing, according to the present invention the data arrival information is transmitted to the user terminal in a network accessing environment based on a radio network by taking the difference of the type of each user terminal, and it is thus possible to permit transmission of data arrival information to each user by taking the difference of the terminal used by each user into considerations.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A data arrival informing system for informing data arrival to a user terminal in a network accessing environment based on a radio network, comprising a data arrival information dealing means for transmitting data arrival information by taking the difference of the type of each user terminal into considerations.

2. A data arrival informing system for informing data arrival to a user terminal in a network accessing environment based on a radio network, comprising a data arrival information dealing means for transmitting data arrival information by taking the difference of the type of each user terminal into considerations which includes a receiving means for receiving the data arrival information, a terminal type storing means for preliminarily storing the type of each user terminal, a data arrival information type determining means for determining the type of the data arrival information received by the receiving means on the basis of each user terminal type stored in the terminal type storing means, a data arrival information editing means for editing data arrival information on the basis of the data arrival information received by the receiving means and the data arrival information type determined by the data arrival information type determining means, and a data arrival information transmitting means for transmitting the data arrival information edited in the data arrival information editing means to the user terminal via the radio network.

3. The data arrival informing system according to claim 2, wherein the data arrival information editing means edits data arrival information taking at least adequate maximum received data quantity and data description language into considerations on the basis of the type of data arrival information determined in the data arrival information type determining means.

4. The data arrival informing system according to claim 2, wherein the data arrival information transmitting means transmits data arrival information taking at least adequate radio network, data transfer protocol and connecting system into considerations on the basis of the type data arrival information as determined on the data arrival information type determining means.

5. The data arrival information editing means according to claim 2, wherein the terminal type storing means has such a construction as to store a predetermined user terminal type.

6. A data arrival informing system for informing data arrival to a user terminal in a network accessing environment based on a radio network, comprising a data arrival information dealing means for transmitting data arrival information by taking the difference of the type of each user terminal into considerations which includes a receiving means for receiving the data arrival information, a terminal type storing means for preliminarily storing the type of each user terminal, a data arrival information type determining means for determining the type of the data arrival information received by the receiving means on the basis of each user terminal type stored in the terminal type storing means, a data arrival information editing means for editing data arrival information on the basis of the data arrival information received by the receiving means and the data arrival information type determined by the data arrival information type determining means, and a data arrival information transmitting means for transmitting the data arrival information edited in the data arrival information editing means to the user terminal via the radio network, the terminal type storing means dynamically storing the user terminal type at the time of the provision of a data-obtaining request from the user terminal.

7. The data arrival informing system according to claim 6, wherein the data arrival information dealing means includes a means for causing the terminal type contained in the data-obtaining request from the user terminal to be read out and stored in the terminal type storing means.

8. A data arrival informing method for informing data arrival to a user terminal in a network accessing environment based on a radio network, comprising a data arrival information dealing step for transmitting data arrival information by taking the difference of the type of each user terminal into considerations.

9. A data arrival informing method for informing data arrival to a user terminal in a network accessing environment based on a radio network, comprising a data arrival information dealing step for transmitting data arrival information by taking the difference of the type of each user terminal into considerations, which includes a receiving step for receiving the data arrival information, a terminal type storing step for preliminarily storing the type of each user terminal, a data arrival information type determining step for determining the type of the data arrival information received by the receiving means on the basis of each user terminal type stored in the terminal type storing means, a data arrival information editing step for editing data arrival information on the basis of the data arrival information received by the receiving step and the data arrival information type determined by the data arrival information type determining step, and a data arrival information transmitting step for transmitting the data arrival information edited in the data arrival information editing step to the user terminal via the radio network.

10. The data arrival informing method according to claim 7, wherein the data arrival information editing step edits data arrival information taking at least adequate maximum received data quantity and data description language into considerations on the basis of the type of data arrival information determined in the data arrival information type determining step.

11. The data arrival informing method according to claim 9, wherein the data arrival information transmitting step transmits data arrival information taking at least adequate radio network, data transfer protocol and connecting system into considerations on the basis of the type data arrival information as determined on the data arrival information type determining step.

12. The data arrival information method according to claim 9, wherein the terminal type storing step has such a construction as to store a predetermined user terminal type.

13. A data arrival informing method for informing data arrival to a user terminal in a network accessing environment based on a radio network, comprising a data arrival information dealing step for transmitting data arrival information by taking the difference of the type of each user terminal into considerations which includes a receiving step for receiving the data arrival information, a terminal type storing step for preliminarily storing the type of each user terminal, a data arrival information type determining step for determining the type of the data arrival information received by the receiving means on the basis of each user terminal type stored in the terminal type storing step, a data arrival information editing step for editing data arrival information on the basis of the data arrival information received by the receiving step and the data arrival information type determined by the data arrival information type determining step, and a data arrival information transmitting step for transmitting the data arrival information edited in the data arrival information editing step to the user terminal via the radio network, the terminal type storing step dynamically storing the user terminal type at the time of the provision of a data-obtaining request from the user terminal.

14. The data arrival informing system according to claim 9, wherein the data arrival information dealing means includes a means for causing the terminal type contained in the data-obtaining request from the user terminal to be read out and stored in the terminal type storing means.
